(19) United States
(12) Patent Application Publication
(10) Pub. No.: US 2016/0092159 A1
(43) Pub. Date: Mar. 31, 2016

(54) CONVERSATIONAL MUSIC AGENT

(71) Applicant: Google Inc., Mountain View, CA (US)

(72) Inventors: Johnny Chen, Mountain View, CA (US); Thomas L. Dean, Los Altos Hills, CA (US); Gabriel Schine, Menlo Park, CA (US); Sudeep Gandhe, Sunnyvale, CA (US); Qiangfeng Peter Lau, Sunnyvale, CA (US)

(21) Appl. No.: 14/502,155

(22) Filed: Sep. 30, 2014

(51) Int. Cl. G06F 3/16; G06N 5/02

(52) U.S. Cl. CPC G06F 3/165; G06N 5/02

(57) ABSTRACT

Methods, systems, and apparatus, including computer programs encoded on a computer storage medium, for identifying desired music content. The methods, systems, and apparatus include actions of obtaining a transcription and determining that the transcription includes (i) an at least inferential reference to particular music content, or to one or more attributes of the particular music content, and (ii) one or more terms of comparison, affirmation, or negation. Additional actions include identifying one or more attributes of desired music content based on (i) the at least inferential reference to particular music content, or to the one or more attributes of the particular music content, and (ii) one or more terms of comparison, affirmation, or negation. Further actions include identifying the desired music content based on the one or more attributes of the desired music content.

### TECHNICAL FIELD

This disclosure generally relates to natural language processing.

### BACKGROUND

A computer may play music to a user. For example, a music player running on a computer may receive keyboard or mouse input from a user to indicate that the user has selected a particular song be played. The music player may then play the particular song.

### SUMMARY

In general, an aspect of the subject matter described in this specification may involve a process for managing a conversation about music. To enable managing a conversation about music, a system may identify music that a user references based on the music that the system is playing or has played to the user. For example, in response to receiving an utterance from a user that says “PLAY SOMETHING LIKE THE CURRENT SONG BUT WITH MORE BASS,” the system may identify that “THE CURRENT SONG” refers to the song “‘I GOTTA FEELING’ BY THE BLACK EYED PEAS,” which is currently being played by the system. The system may then generate speech output based on the identification of the song. For example, the system may identify that the song “‘BOOM BOOM POW’ BY THE BLACK EYED PEAS” is similar to the identified song “‘I GOTTA FEELING’ BY THE BLACK EYED PEAS” but has more bass and, in response, may output “DO YOU WANT TO LISTEN TO ‘BOOM BOOM POW’ BY THE BLACK EYED PEAS?”

In some aspects, the subject matter described in this specification may be embodied in methods that may include the actions of obtaining a transcription and determining that the transcription includes (i) an at least inferential reference to particular music content, or to one or more attributes of the particular music content, and (ii) one or more terms of comparison, affirmation, or negation. Additional actions include identifying one or more attributes of desired music content based on (i) the at least inferential reference to particular music content, or to the one or more attributes of the particular music content, and (ii) one or more terms of comparison, affirmation, or negation. Further actions include identifying the desired music content based on the one or more attributes of the desired music content.

Other versions include corresponding systems, apparatus, and computer programs, configured to perform the actions of the methods, encoded on computer storage devices.

These and other versions may each optionally include one or more of the following features. For instance, in some implementations the at least inferential reference to particular music content comprises one or more terms that refer to music content previously presented to a user.

In some aspects, the at least inferential reference to particular music content comprises one or more terms that refer to music content currently being presented to a user.

In certain aspects, the one or more terms of comparison, affirmation, or negation refer to the one or more attributes of the particular music content.

In some implementations, identifying one or more attributes of desired music content based on (i) the at least inferential reference to particular music content, or to the one or more attributes of the particular music content, and (ii) one or more terms of comparison, affirmation, or negation includes determining the one or more attributes of the particular music content from the transcription, identifying the one or more terms of comparison, affirmation, or negation in the transcription, and determining the one or more attributes of desired music content that correspond to the one or more attributes of the particular music content modified by the comparison, affirmation, or negation.

In some aspects, determining the one or more attributes of the particular music content from the transcription includes identifying the at least inferential reference to particular music content in the transcription, identifying the particular music content corresponding to the inferential reference based at least on a music content consumption history, and determining the one or more attributes of the particular music content based at least on a knowledge base. In certain aspects, determining the one or more attributes of the particular music content based at least on a knowledge base includes determining the one or more attributes of the particular music content based at least on a knowledge base when the transcription does not include an explicit reference to an attribute of the particular music content. In some implementations, the at least inferential reference to particular music content in the transcription includes an explicit reference to the particular music content.

In some aspects, actions include generating a suggestion to listen to the desired music content.

The details of one or more implementations of the subject matter described in this specification are set forth in the accompanying drawings and the description below. Other potential features, aspects, and advantages of the subject matter will become apparent from the description, the drawings, and the claims.

### DESCRIPTION OF DRAWINGS

FIG. 1 is a block diagram of a system for managing a conversation about music.

FIG. 2 is another block diagram of the system for managing a conversation about music.

FIG. 3 is a flowchart of an example process for managing a conversation about music.

FIG. 4 is a diagram of exemplary computing devices.

Like reference symbols in the various drawings indicate like elements.

### DETAILED DESCRIPTION

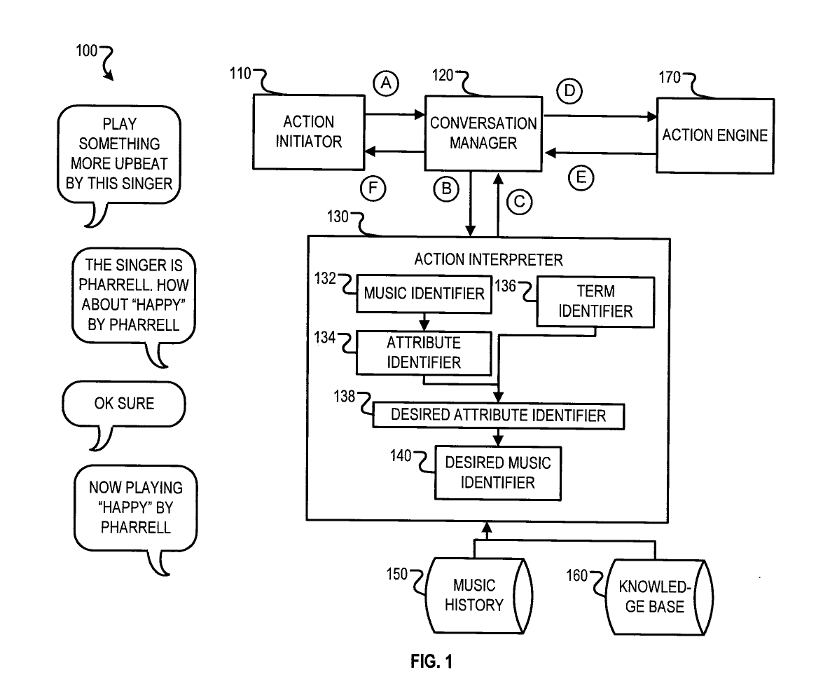

FIG. 1 is a block diagram of a system 100 for managing a conversation about music. Briefly, and as described in further detail below, the system 100 may include an action initiator 110, a conversation manager 120, an action interpreter 130, a music history database 150, a knowledge base 160, and an action engine 170.

The action initiator 110 may determine whether to initiate an action in view of a current context. The context may, for example, specify information regarding a current location of user, current time, current audio inputs, currently played music content, whether music content is currently being played, battery life, or received or output utterances. Music content may refer to musical compositions, including songs, albums, music videos, or musical compilations.

The action initiator 110 may apply one or more rules for determining whether to initiate an action in view of the context and/or settings included in a user profile. For example, the action initiator 110 may apply a rule that specifies that an action for prompting a user whether to listen to music is to be initiated when an obtained context indicates that a user is at a particular location at a particular time, and when an obtained user profile indicates that the user likes to listen to music content with particular attributes at the particular location at the particular time. In a particular example, the action initiator 110 may determine from a context that a user is driving home and initiate a conversation with “LOOKS LIKE YOU ARE DRIVING HOME, DO YOU WANT SOME RELAXING MUSIC?”

In another example, the action initiator 110 may apply a rule that specifies that an action for prompting a user whether to listen to music is to be initiated when an obtained context indicates that the user has uttered a phrase that begins with the terms “PLAY SOMETHING.” For example, the action initiator 110 may receive an utterance “PLAY SOMETHING MORE UPBEAT BY THIS SINGER,” may generate a transcription of the utterance, and, based at least on the occurrence of the terms “PLAY SOMETHING” at the beginning of the transcription, may determine that an action of identifying music content that may be desired by the user is to be initiated. The music content that may be desired by the user is referred to by this specification as “desired music content.” Once the action initiator 110 determines that an action is to be initiated, the action initiator 110 may provide the transcription to the conversation manager 120 so as to commence an action.

The action initiator 110 may additionally or alternatively serve as or manage an interface with a user and may receive output for the user from the conversation manager 120. For example, the action initiator 110 may receive an indication from the conversation manager 120 that the action initiator 110 should provide a prompt of “THE SINGER IS PHARRELL. HOW ABOUT ‘HAPPY’ BY PHARRELL.”

The conversation manager 120 may manage a conversation with a user. For example, the conversation manager 120 may track the latest unanswered questions and the dialog of the conversation to resolve ambiguities in utterances. In a more specific example, the conversation manager 120 may determine when a user says “PLAY SOMETHING ELSE BY THAT SINGER” that the system previously output “HOW ABOUT ‘BABY ONE MORE TIME’ BY BRITNEY SPEARS” so “THAT SINGER” refers to “BRITNEY SPEARS.” The conversation manager 120 may receive transcriptions from the action initiator 110, determine how the transcriptions fit into the monitored conversation, and then output responses or actions to the action initiator 110.

In more detail, the conversation manager 120 may receive a transcription from the action initiator 110 and provide the transcription to the action interpreter 130. For example, the conversation manager 120 may receive a transcription “PLAY SOMETHING MORE UPBEAT BY THIS SINGER” and provide the transcription to the action interpreter 130. The transcription that the conversation manager 120 provides to the action interpreter 130 may be an interpreted transcription that incorporates information from one or more transcriptions. For example, the conversation manager 120 may receive “PLAY SOMETHING BY THIS ARTIST,” output “THIS ARTIST IS BRITNEY SPEARS, HOW ABOUT ‘BABY ONE MORE TIME’ BY BRITNEY SPEARS,” receive a response “I DON'T LIKE THAT SONG, PLAY ANOTHER,” generate an interpreted transcription of “PLAY SOMETHING BY BRITNEY SPEARS THAT IS NOT ‘BABY ONE MORE TIME,’” and provide the interpreted transcription to the action interpreter 130.

In some implementations, the conversation manager 120 may correct errors in the transcription from the action initiator 110 using the tracked dialog. For example, the user may say “PLAY PATTY LABELLE,” the conversation manager 120 may receive an incorrect transcription of “PLAY ADELE” from the action initiator 110, the user may then say “NO, I DON'T WANT ADELE, I WANT LABELLE,” the conversation manager 120 may detect this correction and output “SORRY, DID YOU SAY PATTY LABELLE,” the user may say “YES,” and the conversation manager 120 may then cause the system 100 to play music by Patty Labelle.

The conversation manager 120 may receive an indication of desired music content from the action interpreter 130. For example, the conversation manager 120 may receive an indication of desired music content “‘HAPPY’ BY PHARRELL.” The conversation manager 120 may provide an indication of desired music content and the transcription to the action engine 170. The conversation manager 120 may receive an indication of an action from the action engine 170. For example, the conversation manager 120 may receive an indication “PROVIDE THE PROMPT ‘THE SINGER IS PHARRELL. HOW ABOUT HAPPY BY PHARRELL.’” The conversation manager 120 may provide an indication to the action initiator 110 of an output to provide a user. For example, the conversation manager 120 may provide an indication “PROVIDE THE PROMPT ‘THE SINGER IS PHARRELL. HOW ABOUT HAPPY BY PHARRELL’ to the action initiator 110.

The action interpreter 130 may receive a transcription from the conversation manager 120 and identify desired music content. The action interpreter 130 may include a music identifier 132, an attribute identifier 134, a term identifier 136, a desired attribute identifier 138, and a desired music identifier 140. The action interpreter 130 may be in communication with the music history database 150 and the knowledge base 160.

The music identifier 132 may identify particular music content based at least on the transcription. The transcription may include an at least inferential reference to particular music content. The inferential reference to particular music content may be an indirect reference to particular music content. For example, “THE CURRENT SONG” may be an indirect reference to a particular music content of “‘GET LUCKY’ FEATURING PHARRELL” that is currently being played by the system 100. The at least inferential reference to particular music content may also be an explicit reference to particular music content. For example, “‘GET LUCKY’ FEATURING PHARRELL” in a transcription may be an explicit reference to particular music content.

The music identifier 132 may identify one or more terms in the transcription that correspond to the at least inferential reference to particular music content. For example, the music identifier 132 may identify that the terms “THE CURRENT SONG” are one or more terms that correspond to at least an inferential reference to particular music content and identify that the terms “‘GET LUCKY’ FEATURING PHARRELL” are one or more terms that correspond to at least an inferential reference to particular music content. The one or more terms may include terms that inferentially refer to the currently played particular music content, e.g., “THIS,” “THIS SONG,” “CURRENT SONG,” “WHAT'S ON,” “IN THE BACKGROUND,” “WHAT'S BEING PLAYED,” “SONG BEING PLAYED,”,” or terms that inferentially refer to previously played particular music content, e.g., “PREVIOUS SONG,” “LAST SONG,” “EARLIER SONG,” or “PRIOR SONG,” “WHAT I HEARD.” The one or more terms may include terms that explicitly refer to particular music content. For example, the terms “‘GET LUCKY’ FEATURING PHARRELL” are one or more terms that correspond to an explicit reference to particular music content.

The music identifier 132 may determine whether the one or more terms identified as corresponding to at least an inferential reference to particular music content are one or more terms that correspond to an inferential reference to particular music content. For example, the music identifier 132 may identify that the terms “THE CURRENT SONG” are one or more terms that correspond to an inferential reference to particular music content.

The music identifier 132 may determine whether the one or more terms identified as corresponding to at least an inferential reference to particular music content are one or more terms that correspond to an explicit reference to particular music content. For example, the music identifier 132 may identify that the terms “‘GET LUCKY’ FEATURING PHARRELL” are one or more terms that correspond to an explicit reference to particular music content.

In the case where the music identifier 132 determines that the transcription includes an inferential reference to particular music content, the music identifier 132 may obtain music history from the music history database 150 to determine the particular music content referred to by the inferential reference. For example, if the inferential reference is “THE CURRENT SONG,” the music identifier 132 may obtain music history from the music history database 150 to identify the song that is currently being played to a user. In another example, if the inferential reference is “THE PREVIOUS SONG,” the music identifier 132 may obtain music history from the music history database 150 to identify the song that was previously played to a user.

In the case where the music identifier 132 determines that the transcription includes an explicit reference to particular music content, the music identifier 132 may identify the particular music content from one or more terms in the transcription. For example, the music identifier 132 may identify the particular music content “‘GET LUCKY’ FEATURING PHARRELL” from the terms “‘GET LUCKY’ FEATURING PHARRELL” in the transcription.

Additionally or alternatively, the music identifier 132 may determine that the transcription includes an inferential reference to one or more attributes of particular music content. Attributes of music content may include the name of artist, title, tempo, genre, release date, album, track number, disc number, tempo, mood, tone, length, occasion, beats per minute, composer, producer, or amount of bass. For example, the music identifier 132 may determine that the transcription includes “PLAY SOMETHING LIKE SHANIA TWAIN BUT MORE OLD SCHOOL” and determine that the terms “LIKE SHANIA TWAIN” are an inferential reference to an attribute of artist of the music.

The music identifier 132 may provide an indication of the identified particular music content or the inferential reference to one or more attributes to an attribute identifier 134. For example, the music identifier 132 may provide an explicit reference to the particular music content “‘GET LUCKY’ FEATURING PHARRELL” to the attribute identifier 134. In another example, the music identifier 132 may provide the attribute of artist of “SHANIA TWAIN” to the desired attribute identifier.

The attribute identifier 134 may identify one or more attributes of particular music content. The attribute identifier 134 may receive an explicit reference to particular music content or attributes of particular music content. The attributes of the particular music content may be referred to as reference attributes. For example, the attribute identifier 134 may receive an explicit reference to “‘GET LUCKY’ FEATURING PHARRELL.” In another example, the attribute identifier 134 may receive the reference attribute of artist of “SHANIA TWAIN.”

The attribute identifier 134 may determine if the attribute identifier 134 has received an explicit reference to particular music content or attributes. The attribute identifier 134 may determine it has received an explicit reference to particular music content when the attribute identifier 134 determines that the attribute identifier 134 has received a unique identifier for a particular song. For example, “‘GET LUCKY’ FEATURING PHARRELL,” “GET LUCKY BY DAFT PUNK,” “DAFT PUNK FT. PHARRELL WILLIAMS—GET LUCKY,” may all be unique identifiers for the song “‘GET LUCKY’ FEATURING PHARRELL.” The attribute identifier 134 may determine that the attribute identifier 134 has received a unique identifier for a particular song when the attribute identifier 134 determines that information from the knowledge base 160 indicates that only one song satisfies the information received from the music identifier 132. Additionally or alternatively, the attribute identifier 134 may determine the attribute identifier 134 has received attributes. For example, the attribute identifier 134 may determine the attribute identifier 134 has received the attribute of artist of “SHANIA TWAIN.”

When the attribute identifier 134 determines the attribute identifier 134 has received an explicit reference to particular music content, the attribute identifier 134 may identify reference attributes of the particular music content. For example, in response to determining that the attribute identifier 134 has received an explicit reference to the song “‘GET LUCKY’ FEATURING PHARRELL,” the attribute identifier 134 may determine attributes of the song including a title of “GET LUCKY,” artists of “DAFT PUNK” and “PHARRELL,” genre of “DISCO” and “FUNK,” release date of “Apr. 19, 2013,” length of “6:07,” tempo of “MODERATE.” The attribute identifier 134 may determine the attributes by querying the knowledge base 160 for attributes of the song “‘GET LUCKY’ FEATURING PHARRELL.”

When the attribute identifier 134 determines the attribute identifier 134 has received reference attributes, the attribute identifier 134 may identify additional reference attributes corresponding to the reference attributes from a source outside of the transcription. For example, the attribute identifier 134 may determine the attribute identifier has received the reference attributes of artist of “SHANIA TWAIN” and then determine additional reference attributes of genre of “COUNTRY,” artist gender of “FEMALE,” and release dates of “1993-2014.” The attribute identifier 134 may determine the additional reference attributes by querying the knowledge base 160 for attributes that correspond to the received reference attributes.

The attribute identifier 134 may provide the identified reference attributes to the desired attribute identifier 138. For example, the attribute identifier 134 may provide the identified reference attributes of “GET LUCKY,” artists of “DAFT PUNK” and “PHARRELL,” genre of “DISCO” and “FUNK,” release date of “Apr. 19, 2013,” length of “6:07,” and tempo of “MODERATE” to the desired attribute identifier 138. In another example, the attribute identifier 134 may provide the attributes of artist of “SHANIA TWAIN,” genre of “COUNTRY,” artist gender of “FEMALE,” and release dates of “1993-2014” to the desired attribute identifier 138.

The term identifier 136 may identify one or more terms of comparison, affirmation, or negation in the transcription. The one or more terms of comparison, affirmation, or negation may be terms that indicate a comparison with, affirmation of, or negation of one or more attributes of music content, respectively. Terms of comparison may include, “LIKE,” “SIMILAR TO,” “MORE,” “LESS,” “FASTER,” “SLOWER,” “HIGHER,” “LOWER,” “OLDER,” “NEWER,” “SHORTER,” “LONGER,” “WITH,” “FROM THIS,” etc. Terms of affirmation may include, “UH-HUH,” “BY THIS,” “PERFECT,” “THIS WORKS,” etc. Terms of negation may include, “DIFFERENT,” “ANOTHER,” “DISSIMILIAR,” “NOT LIKE THIS,” or “NOT SIMILAR TO,” “WITHOUT,” etc.

For example, in the transcription “PLAY SOMETHING MORE UPBEAT BY THIS SINGER,” the terms “MORE UPBEAT” may be a term of comparison indicating that a desired attribute of tempo of music content should be higher than the tempo of a current song. In another example, the terms “BY THIS SINGER” in the transcription may be terms of affirmation indicating that desired attribute of artist should be the same as the attribute of artist for the current song. In yet another example, the transcription “PLAY SOMETHING LIKE SHANIA TWAIN BUT MORE OLD SCHOOL” may include the terms of comparison “BUT MORE OLD SCHOOL” that indicate that the music content should be from an earlier era than the era of the currently played music content.

The term identifier 136 may identify one or more terms of comparison, affirmation, or negation in the transcription and provide the one or more terms of comparison, affirmation, or negation to the desired attribute identifier 138. For example, the term identifier 136 may identify the terms of comparison of “MORE UPBEAT” and the terms of affirmation of “BY THIS SINGER” to the desired attribute identifier 138.

The desired attribute identifier 138 may receive the reference attributes from the attribute identifier 134, receive one or more terms of comparison, affirmation, or negation from the term identifier 136, and identify one or more desired attributes for desired music content based on at least the received reference attributes and one or more terms of comparison, affirmation, or negation. For example, the desired attribute identifier 138 may receive the reference attributes “GET LUCKY,” artists of “DAFT PUNK” and “PHARRELL,” genre of “DISCO” and “FUNK,” release date of “Apr. 19, 2013”,” length of “6:07,” and tempo of “MODERATE” and receive one or more terms of comparison, affirmation, or negation of “MORE UPBEAT” and “BY THIS SINGER.” In the example, the desired attribute identifier 138 may then identify one or more desired attributes of artist of “PHARRELL” and tempo of “HIGH.”

The desired attribute identifier 138 may identify the one or more desired attributes for desired music content based on determining to which reference attributes the one or more terms of comparison, affirmation, or negation correspond. For example, the desired attribute identifier 138 may determine the one or more terms of comparison of “MORE UPBEAT” corresponds to the reference attribute of tempo. In another example, the desired attribute identifier 138 may determine the one or more terms of affirmation of “BY THIS SINGER” corresponds to the reference attribute of artist.

The desired attribute identifier 138 may include one or more rules for determining correspondences between reference attributes and one or more terms of comparison, affirmation, or negation. For example, the desired attribute identifier 138 may include a rule that specifies that a term that includes the words “UPBEAT,” “HAPPIER,” or “UPBEATNESS” corresponds to the reference attribute of tempo. Additionally or alternatively, the term identifier 136 may determine the correspondences and indicates the correspondences to the desired attribute identifier 138.

The desired attribute identifier 138 may identify the one or more desired attributes based on the determined correspondence between the reference attributes and the one or more terms of comparison, affirmation, or negation. For example, the desired attribute identifier 138 may determine the desired attribute of tempo as “HIGH” based on an identified correspondence between a reference attribute of tempo of “MODERATE” and one or more terms of comparison of “MORE UPBEAT.” In another example, the desired attribute identifier 138 may determine the desired attribute of artists as “PHARRELL” based on an identified correspondence between a reference attribute of artist of “PHARRELL” and one or more terms of affirmation of “BY THIS SINGER.” In yet another example, the desired attribute identifier 138 may identify the desired attribute of genre of “COUNTRY,” the desired attribute of artist gender of “FEMALE,” and the desired attribute of release dates of “EARLIER THAN 1993.”

The desired attribute identifier 138 may provide the identified desired attributes to the desired music identifier 140. For example, the desired attribute identifier 138 may provide the identified desired attribute of tempo of “HIGH” and the identified desired attribute of artist of “PHARRELL” to the desired music identifier 140. In another example, the desired attribute identifier 138 may provide the identified desired attributes of genre of “COUNTRY,” the desired attribute of artist gender of “FEMALE,” and the desired attribute of release dates of “EARLIER THAN 1993.”

The desired music identifier 140 may receive the desired attributes from the desired music identifier 140 and identify one or more desired music content. For example, the desired music identifier 140 may receive the desired attribute of tempo of “HIGH” and the identified desired attribute of artist of “PHARRELL,” and identify “‘HAPPY’ BY PHARRELL” as the desired music content. In another example, the desired music identifier 140 may receive the desired attributes of genre of “COUNTRY,” the desired attribute of artist gender of “FEMALE,” and the desired attribute of release dates of “EARLIER THAN 1993” and identify “‘I WILL ALWAYS LOVE YOU’ BY DOLLY PARTON” as the desired music content.

The desired music identifier 140 may identify the one or more desired music content based on determining music content that satisfies the desired attributes. The desired music identifier 140 may determine music content that satisfies the desired attributes based on querying the knowledge base 160 for music content that satisfies the desired attributes. For example, the desired music identifier 140 may provide a query to the knowledge base 160 for all songs that have a tempo of “HIGH” that are sung by the artist “PHARRELL.” In another example, the desired music identifier 140 may provide a query to the knowledge base 160 for all songs that have a genre of “COUNTRY,” an artist gender of “FEMALE,” and were released earlier than 1993.

In some implementations, the desired music identifier 140 may also identify desired music content based on a user's music history. The desired music identifier 140 may learn or predict music that the user desires to listen to from the user's music history. For example, when the user is exercising, driving, or relaxing at home and says “RECOMMEND SOME SONGS FOR ME DIFFERENT THAN THE LAST SONG,” the desired music identifier 140 may use a current context and user's music history to identify desired music content.

In some implementations, the desired music identifier 140 may also identify the one or more desired music content based on a user's social media. The desired music identifier 140 may access a user's social media and make recommends based on the accessed social media. For example, the desired music identifier 140 may access a user's social media and determine that the user's friend “BILLY” recommended a song today and in response provide the prompt, “DO YOU WANT TO HEAR A SONG RECOMMENDED BY BILLY TODAY?”

The desired music identifier 140 may provide an indication of the identified desired music content to the conversation manager 120. For example, the desired music identifier 140 may provide the conversation manager 120 an indication that “‘HAPPY’ BY PHARRELL” is the desired music content. In another example, the desired music identifier 140 may provide the conversation manager 120 an indication that “‘I WILL ALWAYS LOVE YOU’ BY DOLLY PARTON” is the desired music content.

The music history database 150 may be a database, such as an entity-relationship database, that stores a history of music content that is provided to a user. For example, the music history database 150 may store an indication of music content that is currently being provided to a user and indications of music content that was provided to the user, and when the previously provided music content was provided to the user.

The knowledge base 160 may be a source of information that provides information regarding music content and attributes of music content. For example, the knowledge base 160 may store records for multiple songs, where each record may indicate the attributes of a particular song.

The action engine 170 may receive an indication of desired music content and the transcription, and determine an action to perform. For example, the action engine 170 may receive the transcription “PLAY SOMETHING MORE UPBEAT BY THIS SINGER” and an indication of desired music content of “‘HAPPY’ BY PHARRELL.” In response, the action engine 170 may determine an action of prompting the user with “THE SINGER IS PHARRELL. HOW ABOUT ‘HAPPY’ BY PHARRELL?” In another example, the action engine 170 may receive the transcription “PLAY SOMETHING LIKE SHANIA TWAIN BUT MORE OLD SCHOOL” and the indication of desired music content of “‘I WILL ALWAYS LOVE YOU’ BY DOLLY PARTON.” In response, the action engine 170 may determine an action of playing the desired music content.

The action engine 170 may determine an action to perform based on applying one or more action rules to the transcription and the desired music content. For example, the action engine 170 may apply an action rule of prompting a user to confirm if a user desires to listen to identified music content. In another example, the action engine 170 may apply an action rule of playing an identified desired music content if no music content is currently being played. The action engine 170 may then provide an indication of the determined action to the conversation manager 120. For example, the action engine 170 may provide an indication to the conversation manager 120 that the action initiator 110 should provide the prompt “THE SINGER IS PHARRELL. HOW ABOUT ‘HAPPY’ BY PHARRELL?” to the user.

In some implementations, the action engine 170 may determine to provide a prompt for clarification and additional identifiers for desired music content. For example, the desired music identifier 140 may identify multiple music content and the action engine may determine to prompt the user for information to select a single particular music content. In a particular example, the user may say “I WANT TO HEAR SOME STING” and the action engine 170 may determine to output, “DO YOU WANT STING AS A SOLO ARTIST OR WHEN HE WAS A MEMBER OF ‘THE POLICE’?” In another particular example, the user may say “PLAY MAKE YOU FEEL MY LOVE,” and the action engine 170 may determine to prompt the user “DO YOU WANT THE ORIGINAL BY BOB DYLAN OR THE ONE BY ADELE?”

The system 100 may enable a conversation between a user and the system 100. For example, the action initiator 110 may output the prompt and in response the system 100 may receive an utterance “OK SURE.” The system 100 may then determine an action of playing the desired music content and notifying the user that the desired music content is being played. For example, the system 100 may output “NOW PLAYING ‘HAPPY’ BY PHARRELL.”

In some implementations, the conversation manager 120 may receive utterances for information regarding musical entities, e.g., artists, musical groups, or bands. For example, the conversation manager 120 may receive the utterance “TELL ME SOME RECENT NEWS ABOUT ADELE” or “WHAT ARE SOME OF HER OTHER FAMOUS SONGS?” The conversation manager 120 may then query the knowledge base 160 for the information and provide a response through the action initiator 110. In some implementations, the action interpreter 130 may also help interpret the utterance for information to provide the information to the user.

Different configurations of the system 100 may be used where functionality of the action initiator 110, conversation manager 120, action interpreter 130, music identifier 132, attribute identifier 134, term identifier 136, desired attribute identifier 138, desired music identifier 140, music history database 150, knowledge base 160, and action engine 170 may be combined, further separated, distributed, or interchanged. The system 100 may be implemented in a single device, e.g., a mobile device, or distributed across multiple devices, e.g., a client device and a server device.

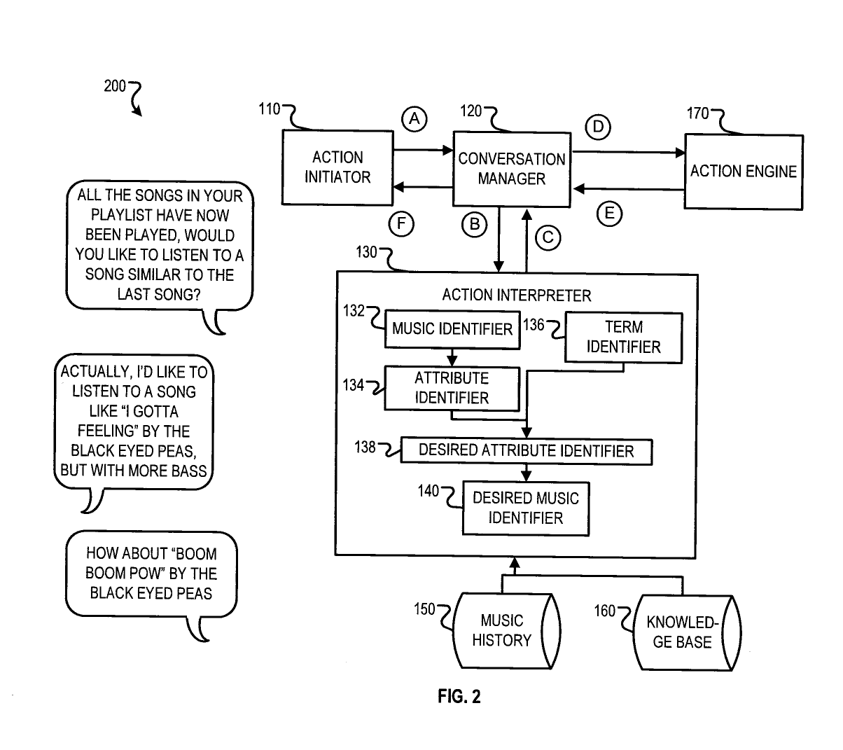

FIG. 2 is another block diagram of the system 200 for managing a conversation about music. The action initiator 110, the conversation manager 120, the action interpreter 130, the music identifier 132, the attribute identifier 134, the term identifier 136, the desired attribute identifier 138, the desired music identifier 140, the music history database 150, the knowledge base 160, and the action engine 170 may be similar to those shown in FIG. 1.

FIG. 2 shows that the action initiator 110 may initiate a conversation with a user. For example, the action initiator 110 may determine to initiate a conversation with the prompt “ALL THE SONGS IN YOUR PLAYLIST HAVE NOW BEEN PLAYED, WOULD YOU LIKE TO LISTEN TO A SONG SIMILAR TO THE LAST SONG?” In this example, in generating the prompt, the action initiator 110 may determine from a context that all the songs in a playlist have been played. In response the determination, the action initiator 110 may determine that provide the prompt.

In response the user may say, “ACTUALLY, I'D LIKE TO LISTEN TO A SONG LIKE ‘I GOTTA FEELING’ BY THE BLACK EYED PEAS, BUT WITH MORE BASS.” The action initiator 110 may receive the utterance, generate a transcription of the utterance, and provide the transcription to the conversation manager 120. The conversation manager 120 may provide the transcription to the action interpreter 130. The music identifier 132 of the action interpreter 130 may identify the explicit reference to “‘I GOTTA FEELING’ BY THE BLACK EYED PEAS” and the attribute identifier 134 may identify the reference attributes of artist of “THE BLACK EYED PEAS,” genre of “HIP HOP,” and amount of bass of “MODERATE” for the song “‘I GOTTA FEELING’ BY THE BLACK EYED PEAS.” The term identifier 136 may identify the term of affirmation “LIKE” and identify the term of comparison “MORE BASS.” The desired attribute identifier 138 may identify the desired attributes of artist of “THE BLACK EYED PEAS,” genre of “HIP HOP,” and amount of bass of “HIGH.” The desired music identifier 140 may identify the song “‘BOOM BOOM POW’ BY THE BLACK EYED PEAS” as desired music content with the desired attributes. The action interpreter 130 may then provide an indication of the song to the conversation manager 120 and the conversation manager 120 may then provide an indication of the song and the transcription to the action engine 170. The action engine 170 may then determine an action of prompting a user with the song to ask the user if the user wishes to listen to the song. The action engine 170 may then provide an indication of the action to the conversation manager 120. The conversation manager 120 may then instruct the action initiator 110 to output, “HOW ABOUT ‘BOOM BOOM POW’ BY THE BLACK EYED PEAS?”

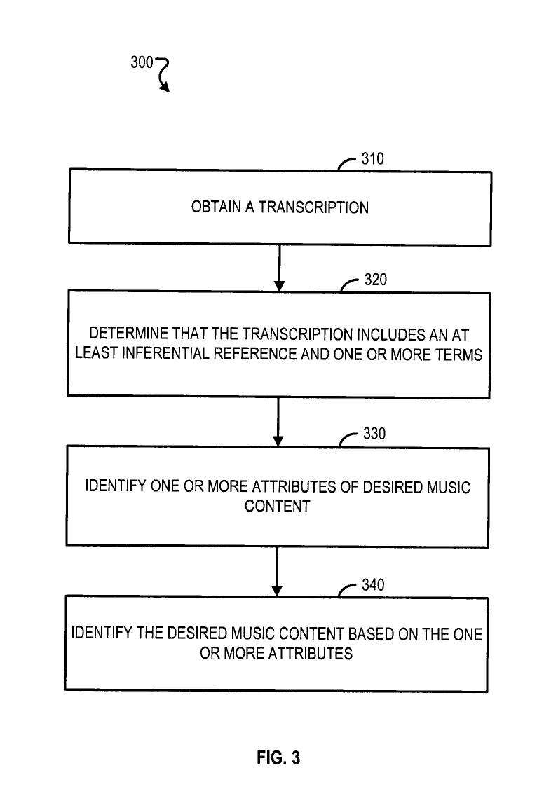

FIG. 3 is a flowchart of an example process 300 for managing a conversation about music. The following describes the processing 300 as being performed by components of the systems 100 and 200 that are described with reference to FIGS. 1 and 2. However, the process 300 may be performed by other systems or system configurations.

The process 300 may include obtaining a transcription (310). For example, the action initiator 110 may receive the utterance “PLAY SOMETHING LIKE SHANIA TWAIN BUT MORE OLD SCHOOL.” The action initiator 110 may then generate a transcription of the utterance.

The process 300 may include determining that the transcription includes an at least inferential reference and one or more terms of comparison, affirmation, or negation (320). For example, the music identifier 132 may determine that the transcription “PLAY SOMETHING LIKE SHANIA TWAIN BUT MORE OLD SCHOOL” includes the explicit reference to the attribute of artist of “SHANIA TWAIN” and the term identifier 136 may determine that the transcription includes one or more terms of comparison of “MORE OLD SCHOOL” and term of affirmation of “LIKE.” In another example, the music identifier 132 may determine that the transcription includes an inferential reference to particular music content and use the music history database 150 to identify the particular music content. For example, the music identifier 132 may determine that the transcription “I LIKE THIS SONG, PLAY ANOTHER LIKE THIS NEXT” includes the inferential reference “THIS SONG” and determine using the music history database 150 that the inference reference refers to the song “‘I GOTTA FEELING’ BY THE BLACK EYED PEAS.”

The process 300 may include identifying one or more attributes of desired music content based on the at least inferential reference and the one or more terms of comparison, affirmation, or negation (330). For example, the attribute identifier 134 may determine using the knowledge base 160 that songs by the artist “SHANIA TWAIN” have the attributes of genre of “COUNTRY,” artist gender of “FEMALE,” and release date of “1993 OR LATER” and provide indications of the attributes to the desired attribute identifier 138. The desired attribute identifier 138 may receive the indications of the attributes and one or more terms of affirmation of “LIKE” and terms of comparison of “MORE OLD SCHOOL” from the term identifier 136 and determine the desired attributes of genre of “COUNTRY,” artist gender of “FEMALE,” and release date of “BEFORE 1993.”

The process 300 may include determining desired music content (340). The desired music identifier 140 may query the knowledge base 160 to identify one or more music content that includes the desired attributes of music content. For example, the desired music identifier 140 may query the knowledge base 160 for songs with the attribute of genre of “COUNTRY,” artist gender of “FEMALE,” and release date of “BEFORE 1993,” and receive an identification of “‘I WILL ALWAYS LOVE YOU’ BY DOLLY PARTON.” The process 300 may also optionally include outputting an indication of the desired music. For example, the process 300 may include the action initiator 110 outputting “HOW ABOUT ‘I WILL ALWAYS LOVE YOU’ BY DOLLY PARTON?”

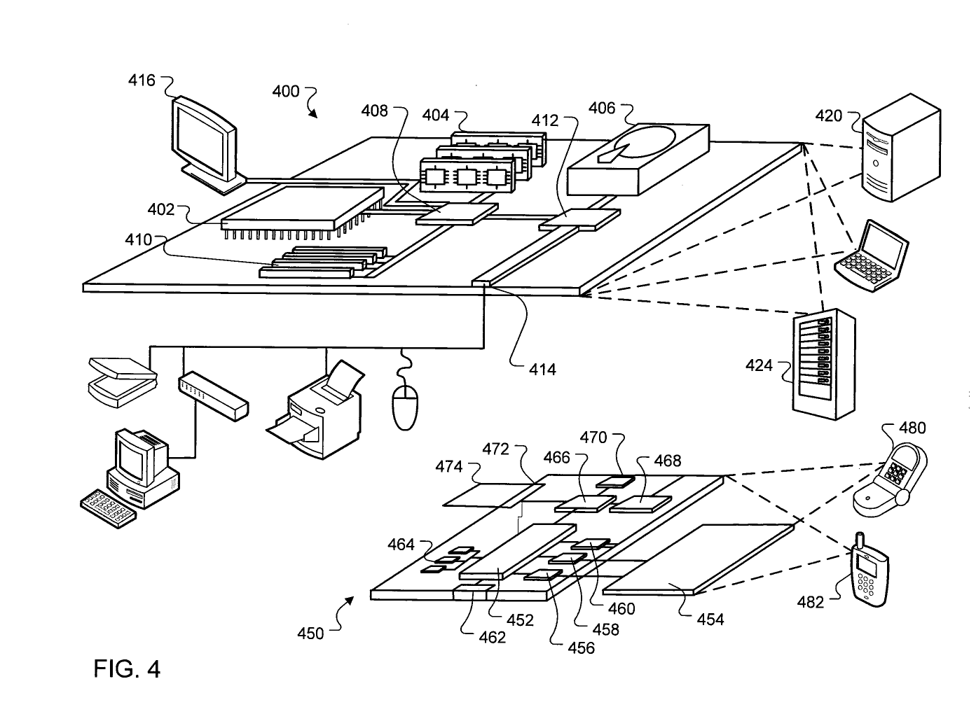

FIG. 4 shows an example of a computing device 400 and a mobile computing device 450 that can be used to implement the techniques described here. The computing device 400 is intended to represent various forms of digital computers, such as laptops, desktops, workstations, personal digital assistants, servers, blade servers, mainframes, and other appropriate computers. The mobile computing device 450 is intended to represent various forms of mobile devices, such as personal digital assistants, cellular telephones, smart-phones, and other similar computing devices. The components shown here, their connections and relationships, and their functions, are meant to be examples only, and are not meant to be limiting.

The computing device 400 includes a processor 402, a memory 404, a storage device 406, a high-speed interface 408 connecting to the memory 404 and multiple high-speed expansion ports 410, and a low-speed interface 412 connecting to a low-speed expansion port 414 and the storage device 406. Each of the processor 402, the memory 404, the storage device 406, the high-speed interface 408, the high-speed expansion ports 410, and the low-speed interface 412, are interconnected using various busses, and may be mounted on a common motherboard or in other manners as appropriate. The processor 402 can process instructions for execution within the computing device 400, including instructions stored in the memory 404 or on the storage device 406 to display graphical information for a graphical user interface (GUI) on an external input/output device, such as a display 416 coupled to the high-speed interface 408. In other implementations, multiple processors and/or multiple buses may be used, as appropriate, along with multiple memories and types of memory. Also, multiple computing devices may be connected, with each device providing portions of the necessary operations (e.g., as a server bank, a group of blade servers, or a multi-processor system).

The memory 404 stores information within the computing device 400. In some implementations, the memory 404 is a volatile memory unit or units. In some implementations, the memory 404 is a non-volatile memory unit or units. The memory 404 may also be another form of computer-readable medium, such as a magnetic or optical disk.

The storage device 406 is capable of providing mass storage for the computing device 400. In some implementations, the storage device 406 may be or contain a computer-readable medium, such as a floppy disk device, a hard disk device, an optical disk device, or a tape device, a flash memory or other similar solid state memory device, or an array of devices, including devices in a storage area network or other configurations. Instructions can be stored in an information carrier. The instructions, when executed by one or more processing devices (for example, processor 402), perform one or more methods, such as those described above. The instructions can also be stored by one or more storage devices such as computer- or machine-readable mediums (for example, the memory 404, the storage device 406, or memory on the processor 402).

The high-speed interface 408 manages bandwidth-intensive operations for the computing device 400, while the low-speed interface 412 manages lower bandwidth-intensive operations. Such allocation of functions is an example only. In some implementations, the high-speed interface 408 is coupled to the memory 404, the display 416 (e.g., through a graphics processor or accelerator), and to the high-speed expansion ports 410, which may accept various expansion cards (not shown). In the implementation, the low-speed interface 412 is coupled to the storage device 406 and the low-speed expansion port 414. The low-speed expansion port 414, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 400 may be implemented in a number of different forms, as shown in the figure. For example, it may be implemented as a standard server 420, or multiple times in a group of such servers. In addition, it may be implemented in a personal computer such as a laptop computer 422. It may also be implemented as part of a rack server system 424. Alternatively, components from the computing device 400 may be combined with other components in a mobile device (not shown), such as a mobile computing device 450. Each of such devices may contain one or more of the computing device 400 and the mobile computing device 450, and an entire system may be made up of multiple computing devices communicating with each other.

The mobile computing device 450 includes a processor 452, a memory 464, an input/output device such as a display 454, a communication interface 466, and a transceiver 468, among other components. The mobile computing device 450 may also be provided with a storage device, such as a micro-drive or other device, to provide additional storage. Each of the processor 452, the memory 464, the display 454, the communication interface 466, and the transceiver 468, are interconnected using various buses, and several of the components may be mounted on a common motherboard or in other manners as appropriate.

The processor 452 can execute instructions within the mobile computing device 450, including instructions stored in the memory 464. The processor 452 may be implemented as a chipset of chips that include separate and multiple analog and digital processors. The processor 452 may provide, for example, for coordination of the other components of the mobile computing device 450, such as control of user interfaces, applications run by the mobile computing device 450, and wireless communication by the mobile computing device 450.

The processor 452 may communicate with a user through a control interface 458 and a display interface 456 coupled to the display 454. The display 454 may be, for example, a TFT (Thin-Film-Transistor Liquid Crystal Display) display or an OLED (Organic Light Emitting Diode) display, or other appropriate display technology. The display interface 456 may comprise appropriate circuitry for driving the display 454 to present graphical and other information to a user. The control interface 458 may receive commands from a user and convert them for submission to the processor 452. In addition, an external interface 462 may provide communication with the processor 452, so as to enable near area communication of the mobile computing device 450 with other devices. The external interface 462 may provide, for example, for wired communication in some implementations, or for wireless communication in other implementations, and multiple interfaces may also be used.

The memory 464 stores information within the mobile computing device 450. The memory 464 can be implemented as one or more of a computer-readable medium or media, a volatile memory unit or units, or a non-volatile memory unit or units. An expansion memory 474 may also be provided and connected to the mobile computing device 450 through an expansion interface 472, which may include, for example, a SIMM (Single In Line Memory Module) card interface. The expansion memory 474 may provide extra storage space for the mobile computing device 450, or may also store applications or other information for the mobile computing device 450. Specifically, the expansion memory 474 may include instructions to carry out or supplement the processes described above, and may include secure information also. Thus, for example, the expansion memory 474 may be provided as a security module for the mobile computing device 450, and may be programmed with instructions that permit secure use of the mobile computing device 450. In addition, secure applications may be provided via the SIMM cards, along with additional information, such as placing identifying information on the SIMM card in a non-hackable manner.

The memory may include, for example, flash memory and/or NVRAM memory (non-volatile random access memory), as discussed below. In some implementations, instructions are stored in an information carrier that the instructions, when executed by one or more processing devices (for example, processor 452), perform one or more methods, such as those described above. The instructions can also be stored by one or more storage devices, such as one or more computer- or machine-readable mediums (for example, the memory 464, the expansion memory 474, or memory on the processor 452). In some implementations, the instructions can be received in a propagated signal, for example, over the transceiver 468 or the external interface 462.

The mobile computing device 450 may communicate wirelessly through the communication interface 466, which may include digital signal processing circuitry where necessary. The communication interface 466 may provide for communications under various modes or protocols, such as GSM voice calls (Global System for Mobile communications), SMS (Short Message Service), EMS (Enhanced Messaging Service), or MMS messaging (Multimedia Messaging Service), CDMA (code division multiple access), TDMA (time division multiple access), PDC (Personal Digital Cellular), WCDMA (Wideband Code Division Multiple Access), CDMA2000, or GPRS (General Packet Radio Service), among others. Such communication may occur, for example, through the transceiver 468 using a radio-frequency. In addition, short-range communication may occur, such as using a Bluetooth, WiFi, or other such transceiver (not shown). In addition, a GPS (Global Positioning System) receiver module 470 may provide additional navigation- and location-related wireless data to the mobile computing device 450, which may be used as appropriate by applications running on the mobile computing device 450.

The mobile computing device 450 may also communicate audibly using an audio codec 460, which may receive spoken information from a user and convert it to usable digital information. The audio codec 460 may likewise generate audible sound for a user, such as through a speaker, e.g., in a handset of the mobile computing device 450. Such sound may include sound from voice telephone calls, may include recorded sound (e.g., voice messages, music files, etc.) and may also include sound generated by applications operating on the mobile computing device 450.

The mobile computing device 450 may be implemented in a number of different forms, as shown in the figure. For example, it may be implemented as a cellular telephone 480. It may also be implemented as part of a smart-phone 482, personal digital assistant, or other similar mobile device.

Embodiments of the subject matter, the functional operations and the processes described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible nonvolatile program carrier for execution by, or to control the operation of, data processing apparatus. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The term “data processing apparatus” encompasses all kinds of apparatus, devices, and machines for processing data, including by way of example a programmable processor, a computer, or multiple processors or computers. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, or a combination of one or more of them.

A computer program (which may also be referred to or described as a program, software, a software application, a module, a software module, a script, or code) can be written in any form of programming language, including compiled or interpreted languages, or declarative or procedural languages, and it can be deployed in any form, including as a standalone program or as a module, component, subroutine, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Computers suitable for the execution of a computer program include, by way of example, can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few.

Computer readable media suitable for storing computer program instructions and data include all forms of nonvolatile memory, media and memory devices, including by way of example semiconductor memory devices, e.g., EPROM, EEPROM, and flash memory devices; magnetic disks, e.g., internal hard disks or removable disks; magneto optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of what may be claimed, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous. Other steps may be provided, or steps may be eliminated, from the described processes. Accordingly, other implementations are within the scope of the following claims.

1. A computer-implemented method comprising:
obtaining a transcription;
determining that the transcription includes (i) an at least inferential reference to particular music content, or to one or more attributes of the particular music content, and (ii) one or more terms of comparison, affirmation, or negation;
identifying one or more attributes of desired music content based on (i) the at least inferential reference to particular music content, or to the one or more attributes of the particular music content, and (ii) one or more terms of comparison, affirmation, or negation; and
identifying the desired music content based on the one or more attributes of the desired music content.

2. The method of claim 1, wherein the at least inferential reference to particular music content comprises one or more terms that refer to music content previously presented to a user.

3. The method of claim 1, wherein the at least inferential reference to particular music content comprises one or more terms that refer to music content currently being presented to a user.

4. The method of claim 1, wherein the one or more terms of comparison, affirmation, or negation refer to the one or more attributes of the particular music content.

5. The method of claim 1, wherein identifying one or more attributes of desired music content based on (i) the at least inferential reference to particular music content, or to the one or more attributes of the particular music content, and (ii) one or more terms of comparison, affirmation, or negation, comprises:
determining the one or more attributes of the particular music content from the transcription;
identifying the one or more terms of comparison, affirmation, or negation in the transcription; and
determining the one or more attributes of desired music content that correspond to the one or more attributes of the particular music content modified by the comparison, affirmation, or negation.

6. The method of claim 5, wherein determining the one or more attributes of the particular music content from the transcription, comprises:
identifying the at least inferential reference to particular music content in the transcription;
identifying the particular music content corresponding to the inferential reference based at least on a music content consumption history; and
determining the one or more attributes of the particular music content based at least on a knowledge base.

7. The method of claim 6, wherein determining the one or more attributes of the particular music content based at least on a knowledge base comprises:
determining the one or more attributes of the particular music content based at least on a knowledge base when the transcription does not include an explicit reference to an attribute of the particular music content.

8. The method of claim 6, wherein the at least inferential reference to particular music content in the transcription comprises:
an explicit reference to the particular music content.

9. The method of claim 1, comprising:
generating a suggestion to listen to the desired music content.

10. A system comprising:
one or more computers and one or more storage devices storing instructions that are operable, when executed by the one or more computers, to cause the one or more computers to perform operations comprising:
obtaining a transcription;
determining that the transcription includes (i) an at least inferential reference to particular music content, or to one or more attributes of the particular music content, and (ii) one or more terms of comparison, affirmation, or negation;
identifying one or more attributes of desired music content based on (i) the at least inferential reference to particular music content, or to the one or more attributes of the particular music content, and (ii) one or more terms of comparison, affirmation, or negation; and
identifying the desired music content based on the one or more attributes of the desired music content.

11. The system of claim 10, wherein the at least inferential reference to particular music content comprises one or more terms that refer to music content previously presented to a user.

12. The system of claim 10, wherein the at least inferential reference to particular music content comprises one or more terms that refer to music content currently being presented to a user.

13. The system of claim 10, wherein the one or more terms of comparison, affirmation, or negation refer to the one or more attributes of the particular music content.

14. The system of claim 10, wherein identifying one or more attributes of desired music content based on (i) the at least inferential reference to particular music content, or to the one or more attributes of the particular music content, and (ii) one or more terms of comparison, affirmation, or negation, comprises:
determining the one or more attributes of the particular music content from the transcription;
identifying the one or more terms of comparison, affirmation, or negation in the transcription; and
determining the one or more attributes of desired music content that correspond to the one or more attributes of the particular music content modified by the comparison, affirmation, or negation.

15. The system of claim 14, wherein determining the one or more attributes of the particular music content from the transcription, comprises:
identifying the at least inferential reference to particular music content in the transcription;
identifying the particular music content corresponding to the inferential reference based at least on a music content consumption history; and
determining the one or more attributes of the particular music content based at least on a knowledge base.

16. The system of claim 15, wherein determining the one or more attributes of the particular music content based at least on a knowledge base comprises:
determining the one or more attributes of the particular music content based at least on a knowledge base when the transcription does not include an explicit reference to an attribute of the particular music content.

17. The system of claim 15, wherein the at least inferential reference to particular music content in the transcription comprises:
an explicit reference to the particular music content.

18. The system of claim 10, the operations comprising:
generating a suggestion to listen to the desired music content.

19. A non-transitory computer-readable medium storing software comprising instructions executable by one or more computers which, upon such execution, cause the one or more computers to perform operations comprising:
obtaining a transcription;
determining that the transcription includes (i) an at least inferential reference to particular music content, or to one or more attributes of the particular music content, and (ii) one or more terms of comparison, affirmation, or negation;
identifying one or more attributes of desired music content based on (i) the at least inferential reference to particular music content, or to the one or more attributes of the particular music content, and (ii) one or more terms of comparison, affirmation, or negation; and
identifying the desired music content based on the one or more attributes of the desired music content.

20. The medium of claim 19, wherein the at least inferential reference to particular music content comprises one or more terms that refer to music content previously presented to a user.
